(19) United States
(12) Patent Application Publication
(10) Pub. No.: US 2003/0169694 A1
(43) Pub. Date: Sep. 11, 2003

(54) Use of alternate ports in spanning tree configured bridged virtual local area networks

(76) Inventor: Michael John Seaman, Belvedere, CA (US)

Correspondence Address: MICHAEL JOHN SEAMAN, 160 BELLA VISTA AVE., BELVEDERE, CA, 94920-2466, US

(21) Appl. No.: 10/384,279

(22) Filed: Mar. 6, 2003

Related U.S. Application Data
(60) Provisional application No. 60/362,434, filed on Mar. 7, 2002.

(51) Int. Cl. H04L 12/28

(52) U.S. Cl. 370/254

(57) ABSTRACT

An improvement to the logic for the use of communication links in data networks that require loop-free forwarding of data frames provides for the use of links identified as alternate, or unused, by spanning tree protocols. While imposing no constraints on the locations of communicating stations in the network that can use the alternate links and requiring neither additional protocol between network devices nor awareness by all devices that alternate links are to be used, the improvement provides the benefits of multiple spanning trees in common network configurations while requiring protocol to compute only a single spanning tree and the benefit of additional network scaling where a number of trees are computed. The improvement is applicable to the Bridged Local Area Networks and the spanning tree protocols specified in IEEE Standards 802.1D and 802.1Q and their amendments and revisions.

### CROSS-REFERENCE TO RELATED APPLICATIONS 0

The present application claims the benefit under 35 U.S.C. Å111(b) and 35 U.S.C. Å119(e) of the provisional application No.60/362,434, filed Mar. 7, 2003, entitled USE OF ALTERNATE PORTS IN SPANNING TREE CONFIGURED BRIDGED VIRTUAL LOCAL AREA NETWORKS, naming inventor Michael John Seaman.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates to network protocols and network intermediate devices executing such protocols; and more particularly to algorithms for selecting paths through a network by computing one or more spanning trees.

Local Area Networks (LANs) specified by Institute of Electrical and Electronic Engineers (IEEE) Standards for Metropolitan Area Networks may be connected together with media access control (MAC) bridges. Bridges interconnect LANs so that stations (typically computers) attached to the LANs operate as if they were attached to a single LAN for many purposes. Each bridge has a number of ports that attach, like stations, to the LANs. A bridge selectively forwards data frames received on any one of these ports to the others. An interconnected Bridged Local Area Network provides for an increase in the physical extent, the number of attached stations and the total performance of a LAN, and for the partitioning of physical LAN support for administration or maintenance. MAC Bridges are specified by IEEE Standard 802.1 D (IEEE Std 802.1 D-1998, IEEE Standards for Local and Metropolitan Area Networks: Media Access Control (MAC) Bridges) and its amendments including IEEE Standard 802.1 w - Rapid Reconfiguration.

When LANs are connected by bridges, it is possible to create loops in the network by providing more than one path between LANs. Since the service provided by the Bridged Local Area Network is intended to closely resemble the service provided by a single LAN, and permits the attachment of stations to any segment, bridges may not add to or otherwise modify the data frames that they forward from one LAN to another so as to prevent loops. The IEEE 802.1 D Standard specifies a distributed protocol that the bridges operate to maintain a fully connected (spanning) and loop-free (tree) active topology for the network. This protocol selects a Port Role for each Bridge Port. Ports with port roles of Root Port or Designated Port participate in the active topology by transmitting and receiving frames to and from the attached LANs, while Ports with port roles of Alternate Port or Backup Port do not.

IEEE Standard 802.1 Q (IEEE Std 802.1 Q-1998, IEEE Standards for Local and Metropolitan Area Networks: Virtual Bridged Local Area Networks) specifies a number of additional octets, known as a VLAN tag, that can be added to and removed from data frames to provide an emulation of several separate Bridged Local Area Networks over the same physical infrastructure of bridges and LANs. In particular the source address learning function of IEEE Std 802.1 D, used by bridges to restrict data frames to the path between their originator and the destination station whose source address has been previously learnt, is commonly extended by VLAN aware bridges to provide independent learning from frames associated with different Virtual LANs (VLANs).

The flexibility provided by VLANs has various uses in campus and metropolitan area networks. One is to use all the LANs to provide paths through the networks, typically by using multiple instances of the standard spanning tree protocol to compute independent port roles for each VLAN. In campus networks this approach is primarily used to make full use of multiple up-links, connections from building basement network intermediate systems to bridges in each floor wiring closet, provided for redundancy in case of equipment failure.

Operating multiple instances of the IEEE Std 802.1 D spanning tree protocol can add significant management overhead, can fail to provide robust loop free behavior when the physical network is changed, and is prone to configuration errors that prevent communication—including the in-band management communication that is often relied upon to correct configuration errors. For these reasons IEEE standard 802.1 s-2002 Multiple Spanning Trees specifies a new protocol that combines the information for multiple spanning trees and facilitates continued communication between the regions (MST Regions) of the network with different multiple spanning tree configurations, on the basis of the connectivity provided by a single common spanning tree. The operation of this protocol makes each MST Region appear similar to a single bridge encompassing the entire region, and thus able to independently determine routing within the region of data frames assigned to various VLANs.

Invention and deployment of a new protocol, particularly one fundamental to network operation, is difficult and always encounters resistance from customers who would rather address requirements with modest changes to existing implementation practice. There is prior art for the use of Alternate Ports, also known as cross-links, while using a single spanning tree protocol. However these, developed prior to the definition and widespread use of VLANs, either require modifications to the forwarded data frames by network intermediate systems or impose restrictions on the locations of intermediate systems or stations in the network together with the requirement for agreement on the use of the cross-link by participating intermediate systems.

The calculation of spanning trees to provide full and loop-free connectivity in networks is not limited to Bridged Local Area Networks. Many protocols, such as those providing multicast for IP routers including OSPF (a common IP routing protocol) based multicast and DVMRP (Distance Vector Multicast Routing Protocol) calculate spanning trees to provide efficient distribution from one source to many destinations. The computation of spanning trees has been suggested to aid in the distribution of routing labels for MPLS (Multi Protocol Label Swapping) which widely advocated to support growth of the Internet and IP related communications.

### BRIEF SUMMARY OF THE INVENTION

This invention comprises: a method for using the ports on a MAC Bridge with the role of Alternate Port, as assigned by the IEEE Standard 802.1 D-1998, IEEE Standard 802.1 w-2001, or similar protocols for computing a spanning tree, to provide communication paths in a Bridged Local Area Network; the extension of this method to Alternate Ports and Master Ports for an MST Region as specified in IEEE Standard 802.1 s-2002; and networks configured so as to use these methods.

According to the invention, a bridge port assigned a role of Alternate Port by the execution of a spanning tree algorithm can be used to provide network connectivity for all frames or frames assigned by the MAC Bridge to some or all VLANs, as an alternative to the connectivity provided by the Root Port. A bridge B may select any of its Alternate Ports for transmission and reception of said frames, independently of decisions made by other bridges, provided that the source address learning carried out by the other bridges in the network for other frames forwarded through the Root Port or other Alternate Ports of said bridge B is independent of said frames. The assignment to a VLAN of said frames is a convenience to assure independent source address learning in typical virtual bridged local area networks. If all frames transmitted by a given source address are assigned to a given VLAN by the bridge B then the use or addition of a VLAN header to the frames is not required as said bridge B can use the source address of said frames to classify them as belonging to a VLAN.

Multiple bridges within any given Virtual Bridged Local Area Network may thus distribute the forwarding of data frames between their Root Port and Alternate Ports. Said bridges may be located anywhere within the network, and may attach to LANs that are attached only to other bridges or to LANs attached directly to stations or to both other bridges and stations. Said other bridges and LANs may be closer to or further away from the spanning tree root without restriction.

For convenience a bridge port chosen, from amongst a bridge's Root Port and Alternate Ports, for the forwarding of frames whose source address learning is independent of other frames is referred to in this description of the invention as a Master Port. The term Master Port is used in IEEE Standard 802.1 s-2002 to refer to the port role assigned for the forwarding of frames from one MST Region to another closer to the spanning tree root of the network. This invention allows greater freedom in the choice of Master Ports for frames assigned to any given set of VLANs, as compared to IEEE Standard 802.1 s-2002. Said IEEE Standard 802.1 s restricts all Master Ports to the same port as the Root Port for the bridge in the single spanning tree that ensures loop-free connectivity between regions.

The present invention allows for use of multiple active up-links in a campus network without the need to migrate from the single spanning tree protocols specified in IEEE Standard 802.1 D (IEEE Std 802.1 D- 1998, IEEE Standards for Local and Metropolitan Area Networks: Media Access Control (MAC) Bridges) and its amendments including IEEE Standard 802.1 w-Rapid Reconfiguration. The present invention further allows for use of multiple links between the MST Regions specified by IEEE Standard 802.1 s-2002 Multiple Spanning Trees, thus allowing the connection of simple bridges or MST Regions around a complex multiple spanning tree network core without foregoing the advantages of multiple up-links.

Other aspects and advantages of the present invention can be seen upon review of the figures and the detailed description that follows.

### BRIEF DESCRIPTION OF THE SEVERAL VIEWS OF THE DRAWING

FIG. 1 illustrates a network configuration and shows that full (spanning) and loop-free (tree) connectivity of a network of bridges and LANs is maintained if the connection of a subtree to the rest of the network through Root Port of the bridge closest to the overall spanning tree root of a spanning tree is replaced by a connection through one of the Alternate Ports in the subtree.

FIG. 2 shows the active topology of the example configuration of FIG. 1 as selected by the operation of a spanning tree protocol (on the left of the page) and the active topology for certain VLANs selected by a Bridge B through its use of one of its Alternate Ports for forwarding (transmitting and receiving) frames assigned to said VLANs (on the right of the page). All or some of the Bridges in the network illustrated by FIG. 2 may implement a protocol that only computes a single spanning tree.

FIG. 3 repeats the active topology of the example configuration of FIG. 1 as selected by the operation of a spanning tree protocol (on the left of the page) and the active topology for certain VLANs selected by a Bridge RR through its use of one of its Alternate Ports for forwarding (transmitting and receiving) frames assigned to said VLANs (on the right of the page). Bridges B and RR implement as similar protocol to that specified in IEEE standard P802.1 s-D11.2 Multiple Spanning Trees and are in the same MST Region.

FIG. 4 illustrates the use of the present invention to fully use links in part of a campus network designed according to general industry guidelines for the design of structured networks. In this example the present invention mimics the benefit achieved through the use of two separate spanning trees while only requiring the use of a single spanning tree protocol.

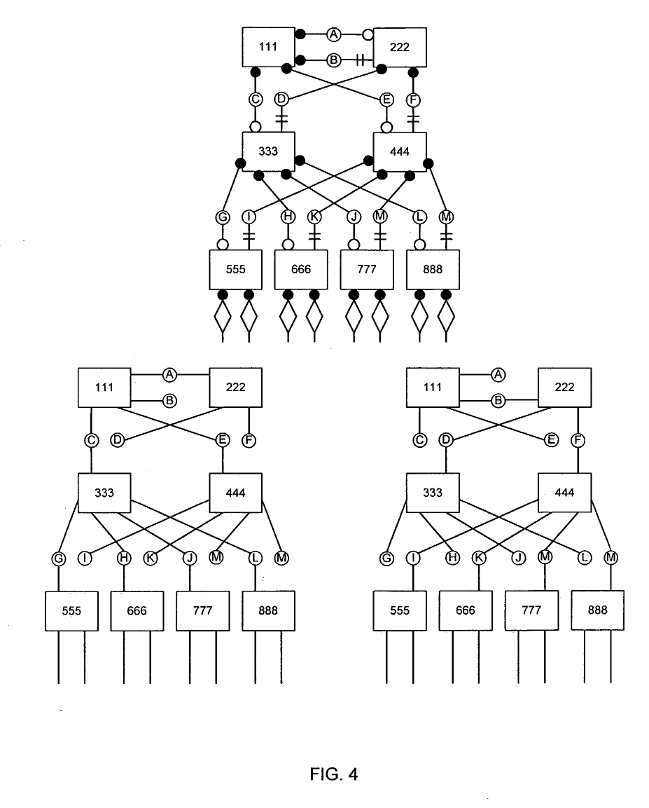

### DETAILED DESCRIPTION OF THE INVENTION

A detailed description of the present invention is provided with reference to the figures.

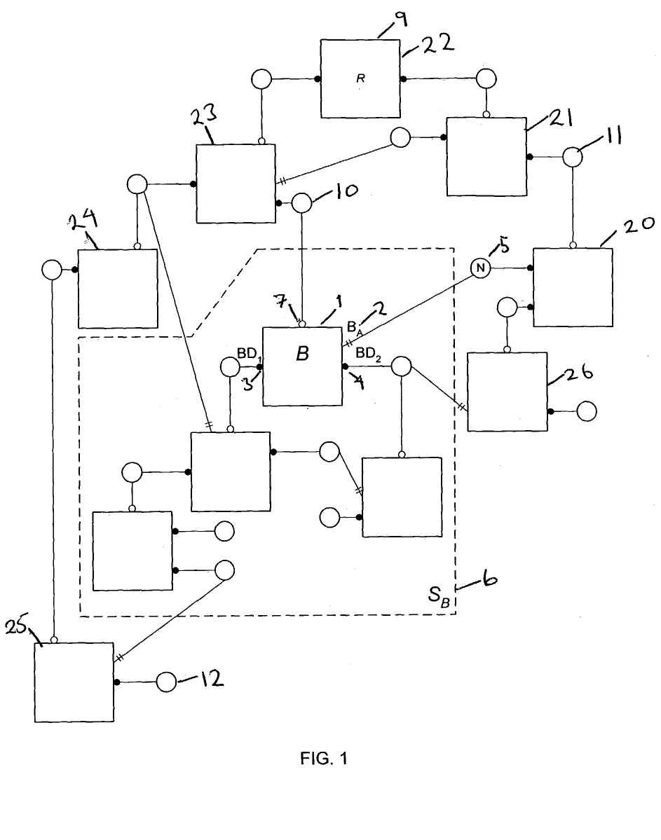

FIG. 1 shows an example network using the diagrammatic conventions specified in IEEE Std 802.1 w-2001 FIG. 17-1 and IEEE Standard 802.1 s-2002 FIG. 13-1 known to those skilled in the art. This network diagram adopts the convention that better spanning tree information, comprising the identifier of a potential spanning tree Root 9 and an arbitrary measure of distance from the Root together with tie breakers, is shown higher on the page. The spanning tree priority information received by any Bridge, B, 1 on one of its Alternate Ports, B_{A}, 2 is better than that advertised by the Bridge on all of its Designated Ports, B_{D1}, B_{D2},. . .3 and 4.Thus the LAN, N, 5 connected to by B_{A} 2 is not in the subtree, S_{B}, 6 that is connected through B_{D}* 3 and 4 to the rest of the Bridged Local Area Network by B's Root Port B_{R} 7.

Since the spanning tree is “spanning”, i.e. fully connects all LANs, N 5 is connected to all the LANs (including 10,11,12) not in S_{B} by bridges (including 20,21,22,23,24,25,26) other than B. Since the spanning tree is “tree”, i.e. simply connects all LANs, no LAN in S_{B} 6 is connected to any LAN not in S_{B} by any Bridge other than B 1. Hence the substitution of forwarding through B_{A} 2 for forwarding through B_{R} 7 preserves the spanning and tree attributes of the active topology.

While any Alternate Port can be chosen, at least in principle, in preference to a Bridge's Root Port it is desirable that we retain predictability and manageability of the choice, and provide a model and terminology for what happens. In one preferred embodiment a set of MSTI (multiple spanning tree instance) port path cost parameters, as described in proposed Draft Standard P802.1 s-D11.2, can be associated with the VLANs that are to be routed separately from the normal spanning tree. The selected Alternate Port becomes the Master Port for the MSTI and hence for the assigned VLANs, and it is selected by adding the port path cost for the MSTI to the received root path cost for the single spanning tree, choosing the port with the lowest resulting cost as usual.

This use of parameters and terminology makes it particularly easy to extend the model to true multiple spanning trees where the single spanning tree becomes the common and internal spanning tree (CIST) referred to in IEEE Standard 802.1 s-2002 and the single bridge becomes an MST Region. However it should be clear that there is only a single spanning tree in this figure.

A wide range of models and local policies are contemplated by the current invention, in addition to the preferred embodiment described above, for assigning VLANs to Alternate Ports, or for assigning Master Ports for VLAN sets (which is another way of expressing the same thing). One is the implementation of a best fit algorithm between the expected bandwidth on each VLAN and the bandwidths of the Root Port and potential Master Ports. Another is the addition of information per VLAN to the single spanning tree to express resource consumption from the root.

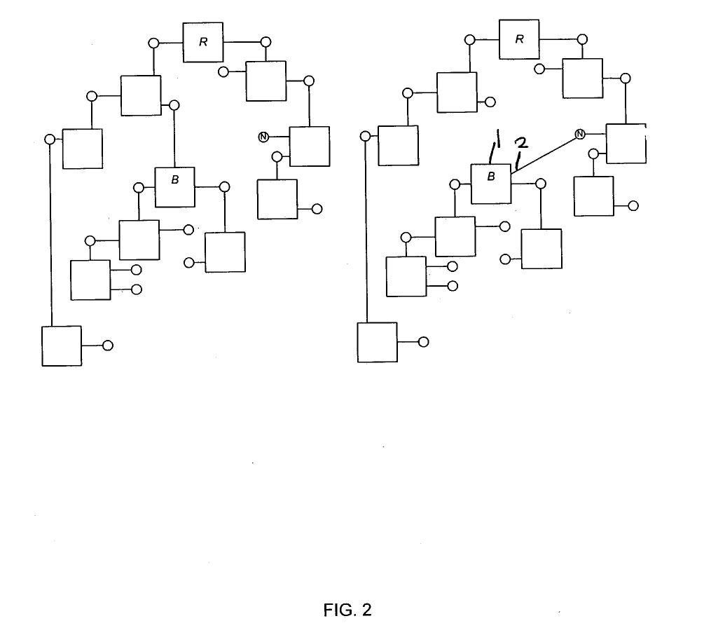

FIG. 2 shows the active topology of the example configuration of FIG. 1 as selected by the operation of a spanning tree protocol (on the left of the page) and the active topology for certain VLANs selected by a Bridge B through its use of one of its Alternate Ports for forwarding (transmitting and receiving) frames assigned to said VLANs (on the right of the page). All or some of the Bridges in the network illustrated by FIG. 2 may implement a protocol that only computes a single spanning tree.

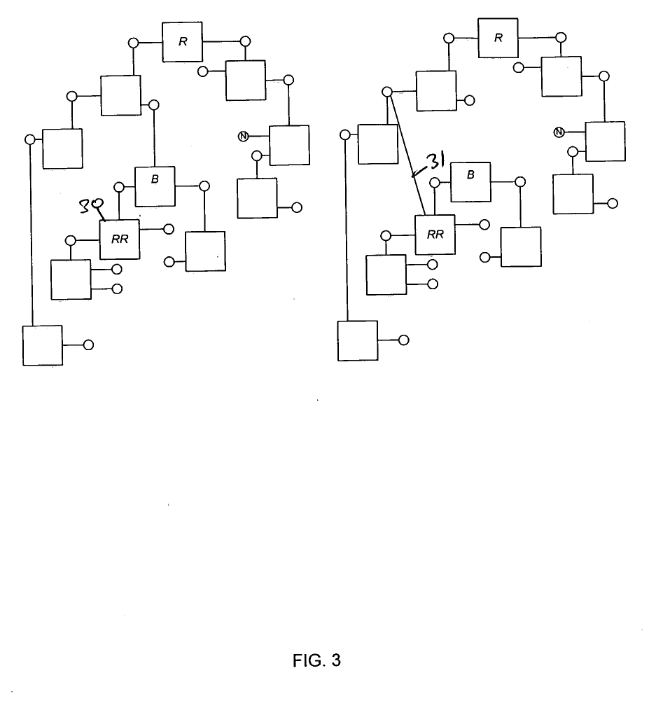

FIG. 3 repeats the active topology of the example configuration of FIG. 1 as selected by the operation of a spanning tree protocol (on the left of the page) and the active topology for certain VLANs selected by a Bridge RR 30 through its use of one of its Alternate Ports 31 for forwarding (transmitting and receiving) frames assigned to said VLANs (on the right of the page). Bridges B 1 and RR 30 implement as similar protocol to that specified in IEEE Standard 802.1 s-2002 Multiple Spanning Trees and are in the same MST Region.

According to the present invention (and given appropriate additional protocol inside an MST Region) the CIST Regional Root, the MSTI (Multiple Spanning Tree Instance) Regional Root, and the MSTI Master Bridge (the MST Bridge at the Region Boundary that has the MSTI Master Port for the Region) contemplated by IEEE Standard 802.1 s-2002 can all be independent. In one preferred embodiment the MSTI Regional Root signals whether it has a CIST Alternate Port at the MST Region Boundary that said MSTI Regional Root wishes to uses as the MSTI Master Port for the Region. If said MSTI Regional Root does not send said signal the CIST Regional Root assigns said Master Port role to its Root Port or one of its Alternate Ports.

The present invention is not limited to the field of Bridged Local Area Networks and may be applied whenever multiple spanning tree paths are desired, so as to reduce the number of trees computed for a given number of computed paths, or to increase the number of paths for a given number of trees.

The foregoing description of preferred embodiments of the invention has been presented for the purposes of illustration and description. The description is not intended to be exhaustive or to limit the invention to the precise forms disclosed. Many modifications and variations will be apparent to practitioners skilled in this art.

I claim:

1. For a network comprising a plurality of communication links connected by a plurality of network devices said network being capable of transmitting frames of data, a network device comprising:
a plurality of ports coupled to communication links in the network;
topology management resources which manage the plurality of ports to select a primary active topology that is loop-free by forwarding, that is transmitting and or receiving, frames through one or more ports in the plurality of ports and not forwarding frames through the zero or more other ports in the plurality of ports;
additional logic that augments the said primary loop-free active topology by classifying frames of data according to a plurality of certain criteria known to the device and forwarding frames meeting one or more criteria through a first port that frames would not be forwarded through if the criteria were not met and not forwarding said frames meeting said criteria through a second port that frames would be forwarded through if said criteria were not met.

2. The network device of claim 1, wherein the topology management resources include resources to execute a spanning tree protocol with other network devices to select the primary active topology;
the first port that frames meeting the criteria are forwarded through but would not be forwarded through said first port if said criteria are not met is identified by said spanning tree protocol as an alternate port or equivalent to an alternate port;
the second port that frames meeting the criteria are not forwarded through but would be forwarded through if said criteria are not met is identified by said spanning tree protocol as a root port or equivalent to a root port.

3. The network device of claim 2, wherein the criteria for classifying frames are sufficient to allow the network device and other devices of the plurality of network device in the network to learn the source network address conveyed in a frame meeting one or more of said criteria so as to determine the port of the plurality of ports to be used to transmit frames to that source address.

4. The network device of claim 3, wherein each or some of the plurality of criteria for classifying frames include inspecting a VLAN header forming part of the frame.

5. The network device of claim 3, wherein each of the plurality of criteria for classifying frames ensure that all frames classified as belonging to a given VLAN are forwarded through no more than one of the plurality of ports identified by the spanning tree protocol as:
the root port or an alternate port or equivalent to a root port or equivalent to an alternate port.

6. The network device of claim 3, wherein each of the plurality of criteria for classifying frames ensure that all frames with any given source MAC address are forwarded through no more than one of the plurality of ports identified by the spanning tree protocol as:
the root port or an alternate port or equivalent to a root port or equivalent to an alternate port.

7. The network device of claim 3, wherein each of the plurality of criteria for classifying frames ensure that all frames with any given source MAC address and classified as belonging to any given VLAN are forwarded through no more than one of the plurality of ports identified by the spanning tree protocol as:
the root port or an alternate port or equivalent to a root port or equivalent to an alternate port.

8. The network device of claim 6, wherein the reception of a first frame on a first port of the plurality of ports that are selected by the spanning tree protocol as designated ports or equivalent to designated ports causes the establishment of criteria to classify frames:
received on others of the plurality of ports that are selected by the spanning tree protocol as root port or alternate port or equivalent to a root port or equivalent to an alternate port; and
with the same source MAC address as said first frame;
so as to forward said frames through the one of the root port or alternate port or equivalent port as selected by management choice for said first frame.

9. For a network capable of transmitting frames of data, said network comprising a plurality of communication links connected by a plurality of network devices executing a spanning tree protocol with other network devices to select multiple loop-free spanning tree active topologies and using a convention to said network devices to allocate each data frame to one and only one active topology on the basis of protocol fields in said data frame, a network device comprising:
a plurality of ports coupled to communication links in the network;
topology management resources which manage the plurality of ports to select the spanning tree active topologies;
additional logic that augments one or more of the active loop-free topologies selected by said spanning tree protocol by further classifying frames of data allocated to the said active topology according to a plurality of certain criteria known to the device;
additional logic for forwarding frames meeting one or more of said criteria through a first port that frames would not be forwarded through if said criteria were not met and not forwarding said frames meeting said criteria through a second port that frames would be forwarded through if said criteria were not met.

10. The network device of claim 9, wherein each of the plurality of criteria for classifying frames ensure that all frames classified as belonging to a given VLAN are forwarded through no more than one of the plurality of ports identified by the spanning tree protocol as:
the root port or an alternate port or equivalent to a root port or equivalent to an alternate port.

11. The network device of claim 9, wherein each of the plurality of criteria for classifying frames ensure that all frames with any given source MAC address are forwarded through no more than one of the plurality of ports identified by the spanning tree protocol as:
the root port or an alternate port or equivalent to a root port or equivalent to an alternate port.

12. The network device of claim 9, wherein each of the plurality of criteria for classifying frames ensure that all frames with any given source MAC address and classified as belonging to any given VLAN are forwarded through no more than one of the plurality of ports identified by the spanning tree protocol as:
the root port or an alternate port or equivalent to a root port or equivalent to an alternate port.

13. The network device of claim 9, wherein each of the plurality of criteria for classifying frames ensure that all frames with any given source MAC address and classified as belonging to any given VLAN are forwarded through no more than one of the plurality of ports identified by the spanning tree protocol as

14. The network device of claim 10, wherein the reception of a first frame on a first port of the plurality of ports that are selected by the spanning tree protocol as designated ports or equivalent to designated ports causes the establishment of criteria to classify frames:
received on others of the plurality of ports that are selected by the spanning tree protocol as root port or alternate port or equivalent to a root port or equivalent to an alternate port; and
with the same source MAC address and VLAN classification as said first frame;
so as to forward said frames through the one of the root port or alternate port or equivalent port as selected by management choice for said first frame.

15. The network device of claim 2, wherein one or more of the plurality of ports is attached to a Local Area Network (LAN).

16. The network device of claim 2, wherein the spanning tree protocol is or is a derivative of one of the protocols specified in IEEE Standard 802.1D-1998 or IEEE Standard 802.1w-2001.

17. The network device of claim 9, wherein one or more of the plurality of ports is attached to a Local Area Network (LAN).

18. The network device of claim 9, wherein the spanning tree protocol is or is a derivative of one of the protocols specified in IEEE Standard 802.1D-1998, IEEE Standard 802.1w-2001 or IEEE Standard 802.1s-2002.
